(19) United States
(12) Patent Application Publication
(10) Pub. No.: US 2004/0075647 A1
(43) Pub. Date: Apr. 22, 2004

(54) Keyboard reconfiguration method and device

(76) Inventor: James J. Bean, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/272,843

(22) Filed: Oct. 17, 2002

(51) Int. Cl. G09G 5/00

(52) U.S. Cl. 345/168

(57) ABSTRACT

A data input apparatus for data processing devices is disclosed. The apparatus includes a keyboard structure having a plurality of keys disposed within the keyboard structure. Included within the plurality of keys is at least one key that generates, upon actuation, a reconfiguration signal for reconfiguring the keys. The reconfiguration signal enables unrelated character data, different from the initial layout of the keys, to be entered from the data input apparatus using a single keystroke.

### BACKGROUND OF THE INVENTION

Most computer systems receive a majority of their input data via user manipulation of a peripheral device, and in particular a computer keyboard. One of the most commonly used computer keyboards is the QWERTY keyboard, whose name is derived from the letter layout of the left hand side second horizontal row. The QWERTY keyboard consists in diagrammatic representation of four horizontal rows of alphanumeric keys. The keys on one horizontal row are offset with respect to the keys on adjacent horizontal rows so that diagonal columns are formed.

Generally, one problem with the QWERTY keyboard is that it does not allow character data, other than that identified by the initial layout of the keys, to be entered via a single keystroke. For purposes of this application, a single keystroke is defined as a single pressing and releasing of a key by a user to actuate one or more switches associated with the key. One exception is when a Caps Lock key is activated, which allows single keystroke entry of capitalized letters associated with the alphabet keys of the initial layout of the QWERTY keyboard. Another exception is a Num Lock key, which allows numbers to be entered from supplemental keys of the QWERTY keyboard in place of scrolling and editing functions. While the Caps Lock and Num Lock keys provide single keystroke entry of capital letters and numbers, single keystroke entry of character data unrelated to the initial layout of the keys disposed within the keyboard is not available using a QWERTY keyboard, or other standardized keyboards. For the purposes of this invention, related character data is defined as character data generated from QWERTY keyboards and the like including character data generated upon actuation of a Caps Lock key or a Num Lock key and then actuation of an alphanumeric key of the keyboard. Unrelated character data includes all other character data not sharing this relationship.

Advances in computer technology have resulted in keyboard designs that have added supplemental keys to the QWERTY keyboard, such as arrow keys, Alt and Ctrl keys, number keypads, function keys, etc. Such keys often allow character data, which is not capable of being entered via a single keystroke, to be entered indirectly via a combination of keystrokes involving one or more of the supplemental keys in combination with an alphanumeric key of the QWERTY keyboard. Alternatively, a mouse or other peripheral devices can be used to select character data, e.g., foreign language alphabet characters, via drop down menus.

While the use of supplemental keys and/or peripheral devices have improved data entry into computer systems, more rapid data entry methods and devices for single keystroke entry of character data into computer systems are desired.

### SUMMARY

An apparatus for providing single keystroke data entry into a data processing device is described. One embodiment of the data input apparatus comprises a keyboard having a plurality of keys disposed within the keyboard. Actuation of the keys generates character data associated with the respective keys. Besides having keys for generating character data, the keyboard also includes at least one reconfiguration key disposed therein for reconfiguring the keyboard. Upon actuation of a reconfiguration key, a reconfiguration signal is transmitted to the data processing device resulting in unrelated character data being associated with the keys. That is, the keyboard allows single keystroke entry for different, unrelated sets of character data according to whether the reconfiguration key has been actuated, enabling additional data that can be inputted into the data processing device using a single keystroke.

### DESCRIPTION OF THE DRAWINGS

FIG. 1 is a perspective view of one embodiment of a data processing system having a data input apparatus;

FIG. 2 is a block diagram of control circuitry for the data processing system of FIG. 1.

FIG. 3 is an exploded view of another embodiment of a data input apparatus;

FIG. 4 is top plan view of one embodiment of a data input apparatus arranged as a QWERTY key layout; and

FIG. 5 is top plan view of one embodiment of a reconfigured key layout of the data apparatus of FIG. 4 having keys arranged as a DVORAK key layout.

### DETAILED DESCRIPTION

A data input apparatus for permitting single keystroke entry of multiple sets of character data is set forth. The apparatus, e.g., a computer keyboard, includes at least one reconfiguration key that may be used to reconfigure a keyboard. That is, actuation of one of the reconfiguration keys causes a signal to be transmitted to a central processing and memory unit (hereinafter CPU) of a computer or the like to associate a different set of character data with the keys of the keyboard, and enable single keystroke entry of a new set of character data. For purposes of this application, a reconfiguration includes a rearrangement of two or more of the keys of a keyboard. As an example of one reconfiguration, a first alphabet can be entered into the CPU by single keystroke entry of an alphanumeric keyboard prior to actuation of a reconfiguration key, and a second language could be entered via single keystroke entry after actuation of the reconfiguration key. A second reconfiguration could allow QWERTY character data to be entered prior to actuation of the reconfiguration key, and non-QWERTY character data thereafter. An advantage of such an arrangement is that sets of unrelated character data can be arranged in conjunction with each of the reconfiguration keys to enable single keystroke entry of the different sets of character data. Moreover, enabling single keystroke entry of character data allows users to more rapidly create and edit documents resulting in improved efficiency and less fatigue during data entry.

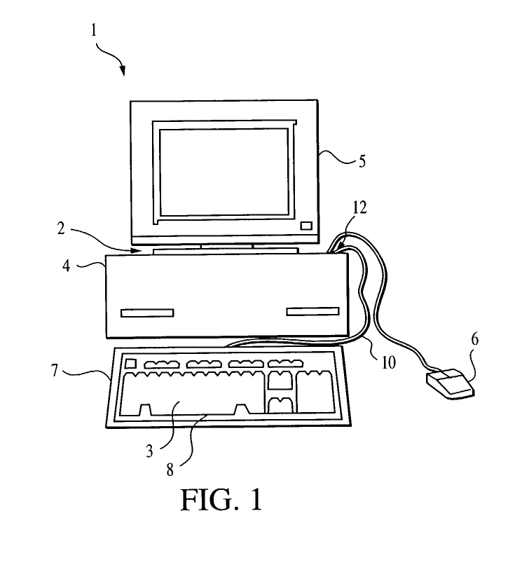

Turning now to the drawings, FIG. 1 is one embodiment of a data processing system 1 which includes a computer 2 having a data input apparatus 3. The data input apparatus 3, e.g., a QWERTY keyboard, is provided with an initial arrangement of keys, and is designed for entering data into a CPU 4 that commonly connects to other peripheral devices. These other peripheral devices may include a monitor 5 for displaying output or character data generated from display signals sent from the CPU 4, and an input device such as a mouse 6. The data input apparatus 3 is formed as a keyboard-type structure or housing, and may include a keyboard base 7 and an upper portion 8, such as a keyframe for housing a plurality of keyboard keys. The upper portion 8 is mateable with the keyboard base 7, and can be fastened to the keyboard base in a variety of methods known to those skilled in the art. The keyboard base 7 is in communication with the computer 2, such as via a transmission line 10, which feeds into the data input apparatus 3. That is, the data input apparatus 3 can connect to the CPU 4 using standard keyboard type connections, with the data input apparatus directly attached to the CPU via an interface 12 of the computer 2. In this type of arrangement, the data input apparatus 3 is configured to allow single keystroke entry of character data including object-orientated characters, which are transmitted as signals to the CPU 4. These signals can then be processed by the CPU 4 to generate characters and/or object-orientated symbols on the display 5. In other embodiments, the upper portion 8 and the keyboard base 7 can be integrated as a single unit to form a keyboard.

In general, a keyboard has several components. These components include a plurality of keys, a keyboard structure which maintains the keys in a pre-arranged position relative to one another and may provide some support against flexure of the keyboard, and a switch assembly for detecting when a key is being pressed or actuated. The keyboard also has a means of communicating this detection to the CPU of the data processing system or computer. Furthermore, the location of keys within the keyboard structure is designed to place the keyboard at a comfortable position to facilitate data entry.

There are also multiple methods of integrating keys, keyboard structures, and the switch assembly together for communicating with a CPU, as those familiar with the art will understand, and the illustrations described herein should not be deemed to be a limitation in how the principle disclosed can be applied to a wide variety of keyboard structures or keyboard designs that use a multitude of keys having various shapes, sizes, and/or orientations.

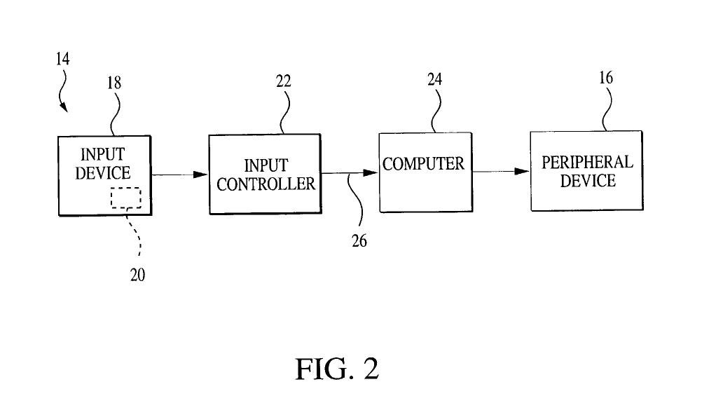

Referring now to FIG. 2, the overall configuration of a control circuit 14 that controls a peripheral device 16 is shown and includes an input device 18, which may include a keyboard having a keyboard base as discussed herein. The input device 18 has a processor 20 (shown in dashed lines) associated therewith that receives a configuration signal upon activation of a reconfiguration key of the input device. Data and control inputs generated by the input device 18 are transmitted to an input controller 22 in electrical communication therewith. Typically, the inputs transmitted to the input controller 22 would include data and/or control inputs for use by a computer 24, as well as the reconfiguration signal input and control inputs for controlling the peripheral device 16. The input controller 22 is provided with programmable code that is configured to read certain ones of the inputs generated by the input device 18 and transmit those inputs to the computer 24 via a bus 26. The computer 24 may propagate control signals to the peripheral device 16, or alternatively, generate control signals for transmission to the peripheral device. By way of example, if the peripheral device 16 is a monitor, the computer can transmit a signal associated with an input of data from the input device 18 to cause character data to be displayed on the monitor.

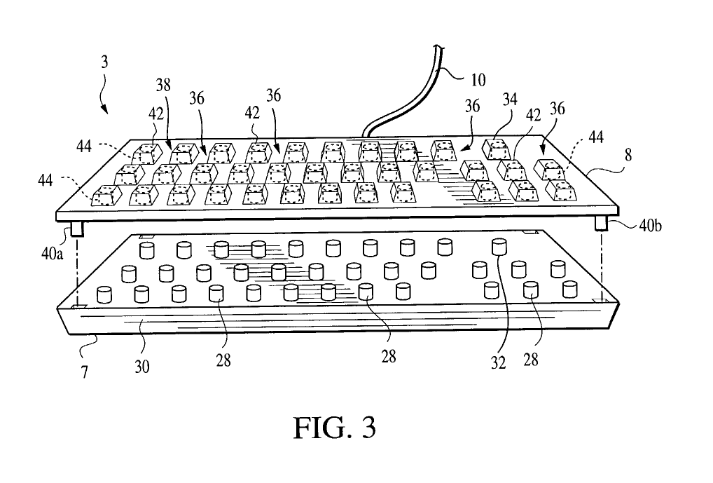

Referring now to FIG. 3, an exploded view of the data input apparatus 3 is shown. The keyboard base 7 includes a matrix of switches 28 that are interconnected by circuitry 30, which can include processors and other electrical components that transmit signals via line 10 upon actuation of the switches as is known to those skilled in the art. In particular, the circuitry 30 connects to at least one reconfiguration switch 32 associated with and actuated by a corresponding reconfiguration key, such as key 34. The reconfiguration key 34 reconfigures character data associated with a plurality of keys 36 of the data input apparatus 3. By way of example, actuation of a key 38 can be configured to generate a letter “s” prior to actuation of the reconfiguration key 34, and a Greek language character “π” after actuation of the reconfiguration key.

This reconfiguration is advantageous since different key layouts for keyboards and similar data entry structures may be provided with a single actuation of a reconfiguration key. Moreover, a second actuation of the reconfiguration key can be configured to return the keyboard to its initial key layout, or alternatively reconfigure the keyboard into a third key layout different from the first two key layouts.

The circuitry 30 processes context information received upon actuation of the reconfiguration key 34 to generate a signal unique to that key, which is provided to the computer 2. Extending members 40a-b may be included to facilitate alignment of the upper portion 8 to the keyboard base 7 upon the mating of these components. It is contemplated, however, that numerous methods of fastening the upper portion 8 to the keyboard base 7, and including one or more reconfiguration keys 34 that are integrated into the circuitry 30 can be implemented as is known to those skilled in the art.

The character data entered by the keys 36 may be identified by a plurality of key caps 42 that overlay actuating members 44 to define the keys. The actuating members 44 actuate respective switches 28 aligned therewith during user keystrokes of the keys 36. The key caps 42 are preferably removable from the keyframe 8 to allow identification of the reconfigured character data associated with the keys 36 upon an actuation of the reconfiguration key 34.

There are many advantages to providing a reconfiguration key for reconfiguring a keyboard. One advantage is that additional character data can be entered from a keyboard using single keystrokes. Another advantage is that different types of keyboards, e.g., QWERTY and DVORAK, can be implemented using a single keyboard. This obviates the need to purchase multiple keyboards for users desiring single keystroke entry of character data that is not normally associated with a QWERTY keyboard. Moreover, the reconfiguration key can be targeted to specific target groups, such as web page designers, graphic artists, accountants, etc.

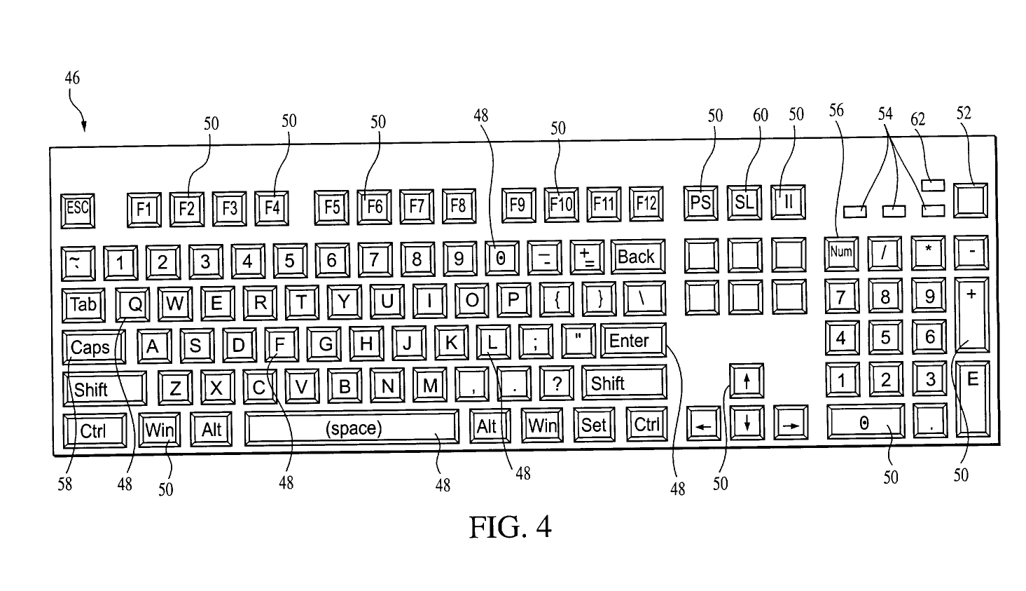

Referring now to FIG. 4, a top plan view of one embodiment of a keyboard 46 is shown. The keyboard 46 includes a plurality of generally alphanumeric and punctuation related keys 48 arranged in a QWERTY keyboard layout for single keystroke entry of character data. The keyboard 46 also includes supplemental keys 50 associated with advanced computer software applications, and a reconfiguration key 52. A plurality of optical windows 54 are used to pass light therethrough and may be used to indicate that a Num Lock key 56, caps lock key 58, and/or a scroll lock key 60 have been activated. The Num Lock key 56 and the Caps Lock key 58 may be activated to enable related character data to be inputted, i.e., capital alphabet characters and/or numerical characters. Similar to the other optical windows 54, an optical window 62 may be used to indicate when the reconfiguration key 52 has been actuated.

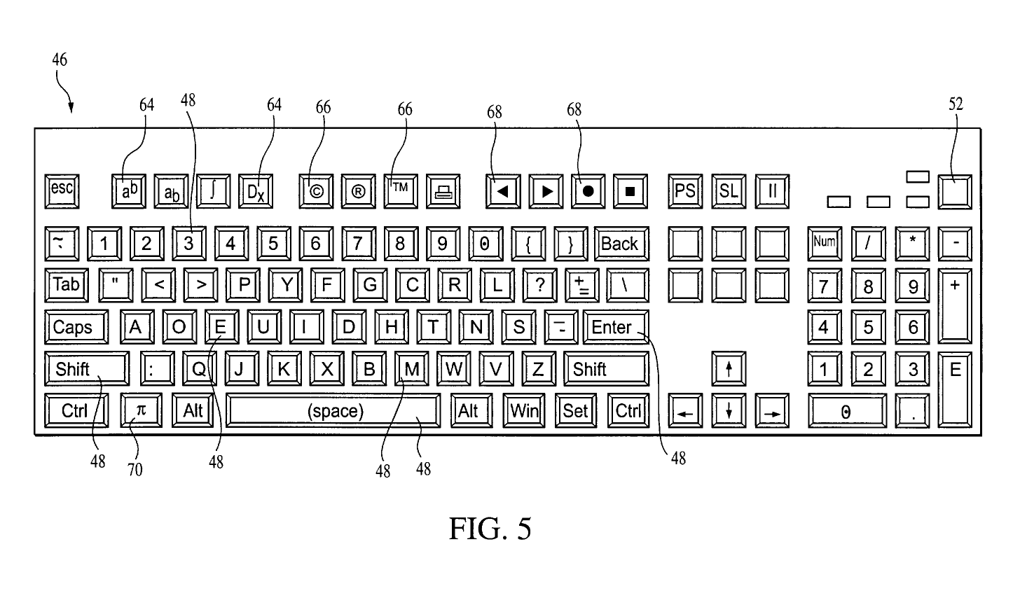

FIG. 5 illustrates an exemplary reconfiguration of the keyboard 46 of FIG. 4 upon actuation of the reconfiguration key 52. The alphanumeric and punctuation keys 48 are arranged in the form of a DVORAK style key layout. In this embodiment, unrelated character data different from the initial key layout of FIG. 4 may be entered via single keystroke entry. For example, several of the supplemental keys 50 of FIG. 4 have been reconfigured as scientific/mathematical keys 64, business keys 66, multimedia keys 68, and a π key 70. The key arrangement of this reconfigured keyboard 46, by way of design, is targeted for mathematical, business, and multimedia users. In particular, the reconfigured keyboard 46 enables single keystroke entry of mathematical object-orientated symbols, business symbols, and multimedia commands.

The computer 2 of FIG. 1 may also include software programs for mapping user-specific keys to the matrix of switches 28, the context of which is defined by the signals supplied by the reconfiguration keys and specific configuration files associated with those keys. Moreover, such software programs can further determine the context of a software application in use and map user key combinations such that certain characters, such as the π symbol 70 of FIG. 5, can be displayed as a symbol or a numerical value according to a particular software package.

It will be appreciated that the selection of the specific keys and individual target group keys, e.g., the mathematical keys 64 of FIG. 5, as well as the overall general selection of whether to include actuating members and keys directed to business, scientific, multimedia, and any other specific target groups on any given keyboard is arbitrary and open to an infinite number of combinations. Selection of particular combinations can be determined according to specific target groups, with keyboards for each target group determined by reconfiguration keys integrated into the keyboard. For example, a function key, non-alphanumeric key, or other key could be used as a reconfiguration key.

It will also be appreciated that the term “computers” as used herein is intended to broadly refer to processor-based devices capable of executing computer readable instructions. A “computer” as used herein is thereby not limited to desktop computers, but includes laptop computers, mainframe computers, and other systems incorporating a CPU and a keyboard for inputting alphanumeric and object-orientated symbols.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A data input apparatus for a data processing device, comprising:
a keyboard structure;
a plurality of keys disposed within said keyboard structure for transmitting character data to the data processing device; and,
circuitry associated with said plurality of keys for enabling transmission of said character data associated with respective ones of said plurality of keys;
wherein a single keystroke of one of said the plurality of keys transmits a reconfiguration signal to the data processing device enabling unrelated character data to be associated with and transmitted by said respective ones of said plurality of keys.

2. The data input apparatus of claim 1 wherein actuation of one of said plurality of keys enables an alphanumeric keyboard configured to input a first language and in communication with the data input apparatus to provide single keystroke entry of a second language.

3. The data input apparatus of claim 1 wherein said keyboard structure includes a keyboard base having said circuitry positioned therein.

4. The data input apparatus of claim 1 wherein said plurality of keys include removable key caps for identifying said plurality of keys.

5. The data input apparatus of claim 1 wherein an initial key layout of said plurality of keys comprises a QWERTY keyboard layout and a reconfigured keyboard layout of said plurality of keys comprises a DVORAK keyboard layout.

6. The data input apparatus of claim 5 wherein a function key of a QWERTY keyboard layout transmits said reconfiguration signal.

7. A keyboard apparatus for use with a computer, comprising:
a plurality of keys transmitting QWERTY character data signals upon actuation of said plurality of keys;
a keyboard keyframe for housing said plurality of keys; and,
means for transmitting a reconfiguration signal to the computer upon a single actuation of one of said plurality of keys to enable single keystroke transmission of non-QWERTY character signals from said plurality of keys.

8. The apparatus of claim 7 wherein said keyboard housing and said plurality of keys form a QWERTY keyboard having a function key for reconfiguring said QWERTY keyboard.

9. The apparatus of claim 7 wherein said reconfiguration signal enables single keystroke entry of a second language from the QWERTY keyboard.

10. The apparatus of claim 7 wherein said means for transmitting a signal to the computer comprises circuitry within said keyboard housing and associated with said plurality of keys.

11. The apparatus of claim 7 wherein a non-alphanumeric key transmits said reconfiguration signal upon said single actuation of one of said plurality of keys.

12. A computer system comprising:
a CPU;
a display unit connected to said CPU for displaying character data; and
an input device for transmitting a first set of signals generating character data associated with keys of said input device to said CPU,
wherein said first input device includes at least one key that, upon actuation, enables said input device to transmit a second set of signals to said CPU, wherein said second set of signals corresponds to unrelated character data associated with said keys of said input device.

13. The computer system of claim 12 wherein the input device is a QWERTY computer keyboard.

14. The computer system of claim 12 wherein said first set of signals are associated with a QWERTY key layout and said second set of signals correspond to a non-QWERTY key layout.

15. The computer system of claim 14 wherein said second set of signals are processed by said CPU to construct one of scientific symbols, non-arithmetic mathematical symbols, multimedia symbols, and business symbols on said display unit.

16. A method of changing a key configuration of a keyboard for a data entry device, the method comprising the steps of:
arranging a plurality of keys associated with a first set of characters on the keyboard; and
providing at least one reconfiguration key of said plurality of keys for transmitting a keyboard configuration signal upon a single keystroke of said reconfiguration key to the data entry device,
wherein said keyboard configuration signal causes a rearrangement of said plurality of keys to generate a second set of characters associated with said plurality of keys of the keyboard.

17. The method of claim 16 wherein said rearrangement of said plurality of keys enables single keystroke entry of characters of a second language from the keyboard.

18. The method of claim 16 wherein said rearrangement is a non-QWERTY key layout of said plurality of keys.

19. A data input apparatus for a data processing device, comprising:
means for electrically communicating with said data processing device;
means for transmitting related character data via said means for electrically communicating; and
means for transmitting a reconfiguration signal to generate unrelated character data via said means for transmitting related character data.

20. The apparatus of claim 19 wherein said means for transmitting related character data comprises a QWERTY keyboard having a plurality of keys disposed therein.

21. The apparatus of claim 20 wherein said means for electrically communicating comprises circuitry associated with said plurality of keys and configured for transmitting signals to the data input apparatus upon actuation of said plurality of keys.

22. The apparatus of claim 20 wherein said means for transmitting a reconfiguration signal comprises a reconfiguration key positioned in said QWERTY keyboard that transmits said reconfiguration signal to the data input apparatus upon actuation of said reconfiguration key.
